(19) United States
(12) Patent Application Publication
(10) Pub. No.: US 2017/0006279 A1
(43) Pub. Date: Jan. 5, 2017

(54) Single Person and Multiple Person Full Resolution 2D/3D Head Tracking Display

(71) Applicant: Dimension Technologies Inc., Rochester, NY (US)

(72) Inventor: Jesse B. Eichenlaub, Penfield, NY (US)

(21) Appl. No.: 15/201,415

(22) Filed: Jul. 2, 2016

Related U.S. Application Data
(60) Provisional application No. 62/187,970, filed on Jul. 2, 2015.

(51) Int. Cl. H04N 13/04

(52) U.S. Cl. CPC H04N 13/0404; H04N 13/0484; H04N 13/0477; H04N 13/0497

(57) ABSTRACT

A single person and multiple person full resolution 2d/3d head tracking display using a light line flashing sequence for full resolution displays using lines of light focused (or otherwise formed) behind a transmissive display, as well as systems for far off axis viewing using a display that focuses light directly into the viewing zones where the eyes are located.

### REFERENCE TO RELATED APPLICATIONS

This application claims one or more inventions which were disclosed in Provisional Application No. 62/187,970, filed Jul. 2, 2016, entitled “Single Person and Multiple Person Full Resolution 2D/3D Head Tracking Display”. The benefit under 35 USC §119(e) of the United States provisional application is hereby claimed, and the aforementioned application is hereby incorporated herein by reference.

### BACKGROUND OF THE INVENTION

### Field of the Invention

The invention pertains to autostereoscopic 3D displays designed for viewing from an area generally in front of the display, as is typical of desktop monitors and TVs.

### Description of Related Art

In autostereoscopic displays, the static viewing zones created by parallax barriers, lenticular lenses, or DTI's basic parallax illumination method are described in numerous patents and publications and are known to impose a restriction on viewer position and freedom of movement in cases where only two perspective views (the left and right views of a stereo pair) are being displayed. If only two views of a stereo pair are displayed on an autostereoscopic display the observer must keep their two eyes positioned within two narrow areas with diamond shaped cross sections at a certain distance from the display, as is well known to the art. DTI has devised a version of its parallax illumination technology called multiplexed backlighting. This technique involves real-time, variable positioning of the light lines behind the LCD. This allows for dynamic control of the parallax illumination and positioning of the viewing zones. When coupled with a head tracking system which provides measurements of a viewer's head position relative to the display, the system can yield a completely unobtrusive stereo display with a wide angle viewing range.

In previous patent, U.S. Pat. No. 5,349,379, which is incorporated herein by reference, it was disclosed how half resolution left and right views of a stereo pair could be produced on a direct view autostereoscopic display using a pattern of light lines behind the LCD, and how the narrow area within which the 3D images are seen can be made to follow the user's head and eyes by means of moving lines or multiple sets of lines that turn and off in response to information provided by a head tracking sensor. As different sets of light lines turn on and off, the viewing zones formed by such light lines in combination with the pixel columns of the LCD will move sideways to follow the head.

This is illustrated in FIG. 1, which is a top view of one viewing zone 1 (which could, for example, be the area of space within which the left eye image of a stereo pair is seen on the display) with a diamond shaped cross section moving to positions 2, 3, 4, 5, and 6 as the observer's eye 7 moves to the right. At the time the patent was applied for there were several options for head tracking devices, including ultrasound echo locators and infrared sensors that reflected light from a reflective dot worn on the head. In recent years, head and eye tracking software, including open source software, has come onto the market that analyses images from a webcam or similar compact camera, identifies eyes, noses, mouths, and other facial features and calculates the positions of these features and the head itself to a very high degree of precision and at a very rapid rate—fast enough to easily keep up with rapid movements of an observer.

U.S. Pat. No. 5,349,379, which is incorporated herein by reference, describes a system where steadily shining light lines are used to display 3D images with half the resolution of an LCD used to form them. Such reduction in resolution is unacceptable in some applications.

In previous patents, such as U.S. Pat. No. 5,036,385, which is incorporated herein by reference, methods of generating 3D images were disclosed using liquid crystal displays and time multiplexed lighting systems in such a way that the full resolution of the LCD is visible to each of the observer's eyes. Such a system can provide two perspective views at full resolution or multiple perspective views at full resolution, depending on how fast the LCD can be driven and how fast the light sources turn on and off. A superior version of this system is disclosed in U.S. Pat. No. 8,189,129, which is incorporated herein by reference, in which slanted light line patterns allow superior visual performance.

The simplest versions of such a full resolution system uses two sets of flashing light lines, as shown in FIG. 2. A backlight, 20, designed to emit light from a plurality of light emitting vertical lines, or columns of line segments, 22 and 23, is situated behind and spaced apart from a liquid crystal display (LCD) 24. The LCD 24 is transmissive, and forms images by varying the transparency of individual pixels 25. Usually these pixels 25 are arranged in straight rows and columns The illuminating lines as shown in FIG. 2 consist of two sets, 22 and 23. Each set of lines is situated such that, as seen from a line 26, in viewing plane 27, each light emitting line appears to be directly behind the boundary of two columns of pixels, 28 and 29.

Means is provided to cause each set of lines 22 and 23 to blink on and off very rapidly, or appear to do so, in such a manner that set 22 is on when set 23 is off, and vice versa. To an observer in front of panel 21, this would give the illusion that light emitting lines are “jumping” back and forth between locations 22 and locations 23. However, in actual operation the lines will blink on and off at the rate of at least 30 times per second, making the blinking too fast to be detected by the observer.

LCD 24 is synchronized with backlight 21 by means of appropriate circuitry and or electronics in such a manner that, when lines 22 are on, columns 28, in front of and to the left of lines 22, are displaying parts of a left eye image of some scene, and columns 29, in front of and to the right of lines 22, are displaying parts of a right eye image of the same scene. While lines 22 are on, an observer with his left eye in zone 30 and his right eye in zone 31 will see a stereoscopic image with the illusion of depth. One sixtieth of a second (or less) later, when lines 22 are off and lines 23 are on, columns 28, which are now in front of and to the right of the illuminating lines 23, display part of a right eye image, instead of a left eye image, and columns 29, in front of and to the left of lines 23, display a left eye image. Again, the observer, situated with his left eye in zone 30 and his right eye in zone 31, sees a stereoscopic image. The observer's left eye, in zone 30, thus first sees lines 22 through columns 28, and thus sees only the image displayed on columns 28. The resolution of this image in the horizontal direction is n/2, where n is the number of pixel columns on the transmissive display. One sixtieth of a second later, the observer sees lines 23 through columns 29, which previously were invisible. Thus, through the 1/30th second cycle, the observer's left eye sees a left eye image formed by all the pixels on the transmissive display. This image has full resolution n in the horizontal direction. The same is true of the observer's right eye. Thus, the observer sees a stereoscopic image with full resolution m by n.

U.S. Pat. No. 5,457,574, which is incorporated herein by reference, describes a full resolution head tracking display with flashing light lines, but does not describe the sequence in which the flashing lines should turn on and off to follow the head. Optimal line turn on and turn off sequences for a full resolution head tracking display are one of the subjects of this invention.

Multiview displays exist which use several perspective views to create the 3D image instead of just two, which allow the observer considerable freedom of head movement. However such displays are unsuitable for use in many if not most applications because of an effect called “image jump” in which images extending more than a few inches from the screen appear to “jump” between different perspectives as the observer moves from side to side. This forces most 3D scenes to be “squashed” in the direction perpendicular to the screen surface. This is acceptable in applications where the display is simply being used to catch viewer's attention, as in advertising, but is not acceptable in applications where images with true proportions in all dimensions are required, such as medicine, CAD, remote vehicle driving, and others, or entertainment applications like television where content creators wish to show a great deal of depth. Furthermore, most 3D content consists of two views of a stereoscopic pair, a left eye view and a right eye view, generated by two cameras (or virtual cameras for computer generated images) and designed to be used with 3D glasses. Multiview displays, however, require more than two views, which requires entirely new content to be produced or existing content to be modified at considerably greater expense. Therefore the head tracking system combined with a means to cause viewing zones displaying two perspective views to follow the head as the observer moves would be very beneficial feature to use with displays simply because it could make use of nearly all existing content without modification to the content.

It is also desirable to display autostereoscopic images at full resolution. High resolution is required for most applications today, including entertainment, where HD is the norm and 4K is rapidly gaining market share. Such displays can also potentially be used on cell phones and other small devices, where lower resolution LCDs are used, and further resolution loss is more of an issue. The use of multiple sets of flashing light lines in combination with a head tracking system is more complex but also offers a greater degree of flexibility than simpler half resolution system.

The adaptation of a parallax illumination system, which uses a backlight that displays lines of light behind the LCD instead of barriers or optics in front, is also desirable from the standpoint of the lack of light loss and lack of visual artifacts associated with an illumination system.

The ability to switch between 2D and 3D image display is also a desirable feature for most displays, since the devices on which 3D images are shown will in many cases be also be used for non-3D applications.

OpenCV is an open source software suite for machine vision that has a module which can work with a webcam to identify/track the head. Carnegie Mellon Researchers, among others, have used OpenCV to track a person's head and change the viewpoint of the image on a 2D screen.

Neurotechnology offers an SDK-containing face recognition algorithm that could be used for head position tracking.

Researchers at the University of Toronto used a webcam for passive tracking of a person's head, and use it to change the viewpoint in Pymol molecular modeling program to produce a look around illusion.

A number of people and research groups have also used game console (PS3, Wii) motion trackers for head tracking with simultaneous changes in perspective view on images displays on 2D or stereoscopic 3D displays.

Other commercial systems for multiple person head tracking or motion sensing use magnetic sensors or passive reflectors worn by the observer, but these are not considered suitable for this application since the worn items can be as obtrusive as 3D glasses.

Head tracking systems, but without the full resolution feature, have been demonstrated by Toshiba and others. Such head tracking systems have the disadvantage that double images and artifacts temporarily become visible as the person crosses the viewing zone boundary, and that observers can wind up stopping their movement with their eyes right at the pixel boundary or very close to it, where double images will always be visible.

The prior art devices described above suffer from major limitations which would prevent them from being used as acceptable solutions for televisions and collaborative displays:

1) Users must be positioned very close to a specific plane. They cannot freely position themselves anywhere within a room, as when viewing a normal 2D TV or monitor.

2) The off axis viewing range is very limited, due to limitations on the focal ratio of the Fresnel lens (or lenses). As a rule of thumb, it is doubtful that a Fresnel lens could provide very good imaging with a focal ratio of less than 1; furthermore, the imaging capability of such a short focal ratio lens tends to degrade considerably off axis; which would limit the off axis viewing range.

3) The off axis viewing is also hindered by the fact that the light source positions needed to create focused areas of light far off axis need to be positioned far off axis from the lens array used to focus them. In the case of the single Lens array version, this would require that the backlight be very large and stick out far to the sides and to some extent beyond the top and bottom of the LCD. For example, a display with a single f/1 Lens array and a +/−60 degree off axis viewing area would require a backlight system that is almost 2.5 times wider than the display. For a compact, multiple Lens array system, the extension out the sides would only be a few inches, depending on the exact design, but another problem will occur. Each off axis light source will send light to several Lens arrays in front of it, and thus will produce a whole collection of focused light spots, only one of which is in the proper position, focused by the correct Lens array around the eye of one person who is being tracked. That is okay if a comparatively narrow viewing area in front of the display is being accommodated, since the unwanted light will be focused outside the narrow area. But if the viewing area itself is very wide, extra “copies” of each focused light spot could wind up sending light to the wrong eye of the wrong person.

### SUMMARY OF THE INVENTION

The present disclosure presents a single person and multiple person full resolution 2d/3d head tracking display using a light line flashing sequence for full resolution displays using lines of light focused (or otherwise formed) behind a transmissive display. The present disclosure also presents systems for far off axis viewing using a display that focuses light directly into the viewing zones where the eyes are located.

### BRIEF DESCRIPTION OF THE DRAWING

FIG. 1 shows a top view of one prior art viewing zone.

FIG. 2 shows a view of a full resolution system of the prior art, using two sets of flashing light lines.

FIG. 3 shows a diagram of a backlight for a full-resolution head tracking system with four sets of flashing lines.

FIG. 4 shows a diagram of a backlight for a full-resolution head tracking system with six sets of flashing lines.

FIG. 5 shows a top view of an illumination system backlight.

FIG. 6 shows a perspective view of a multi person full resolution head tracking display.

FIG. 7 shows a diagram of a multi person full resolution head tracking display of FIG. 6.

FIG. 8 shows a perspective view of another embodiment of the multi person full resolution head tracking display.

FIG. 9 shows a diagram of the multi person full resolution head tracking display of FIG. 8.

FIG. 10 shows a perspective view of a fly's eye lens.

FIGS. 11a-11d show a top view of a system having improved off-axis performance

FIG. 12 shows a variation of the system of FIGS. 11a-11d.

FIGS. 13a-13b show a top view of the object and image planes of a lens

FIG. 14 shows a variation on FIG. 12, using a movable lens array.

FIG. 15 shows a variation on FIG. 14, using a spring-loaded frame and cam system.

FIG. 16 shows a head tracking display using an array of fly's eye lenses behind a display.

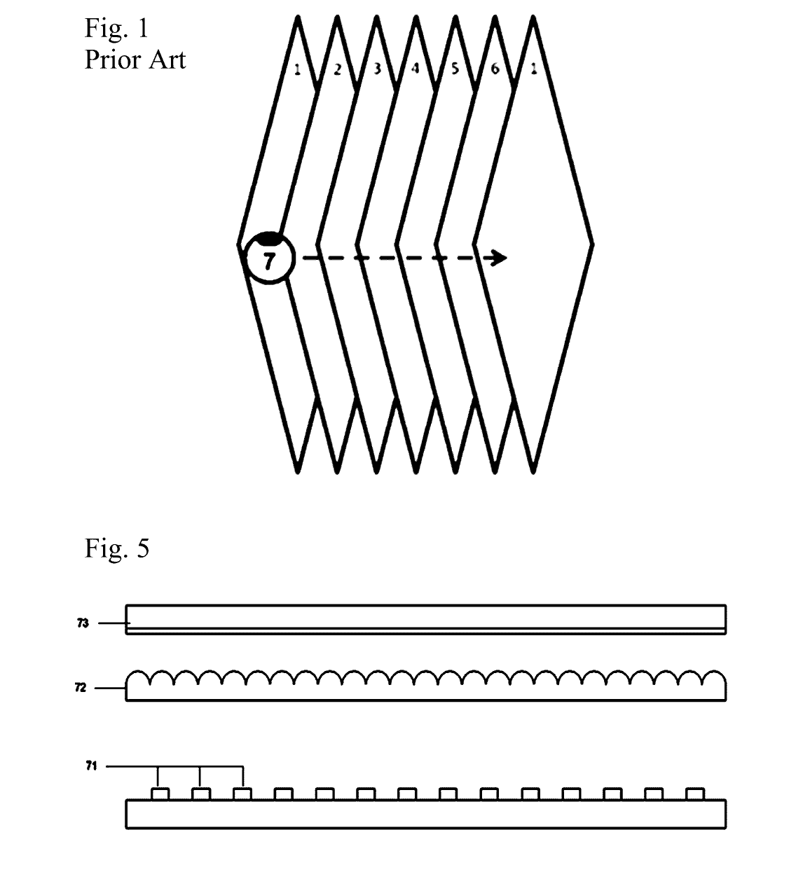

### DETAILED DESCRIPTION OF THE INVENTION

### Head Tracking at Full Resolution

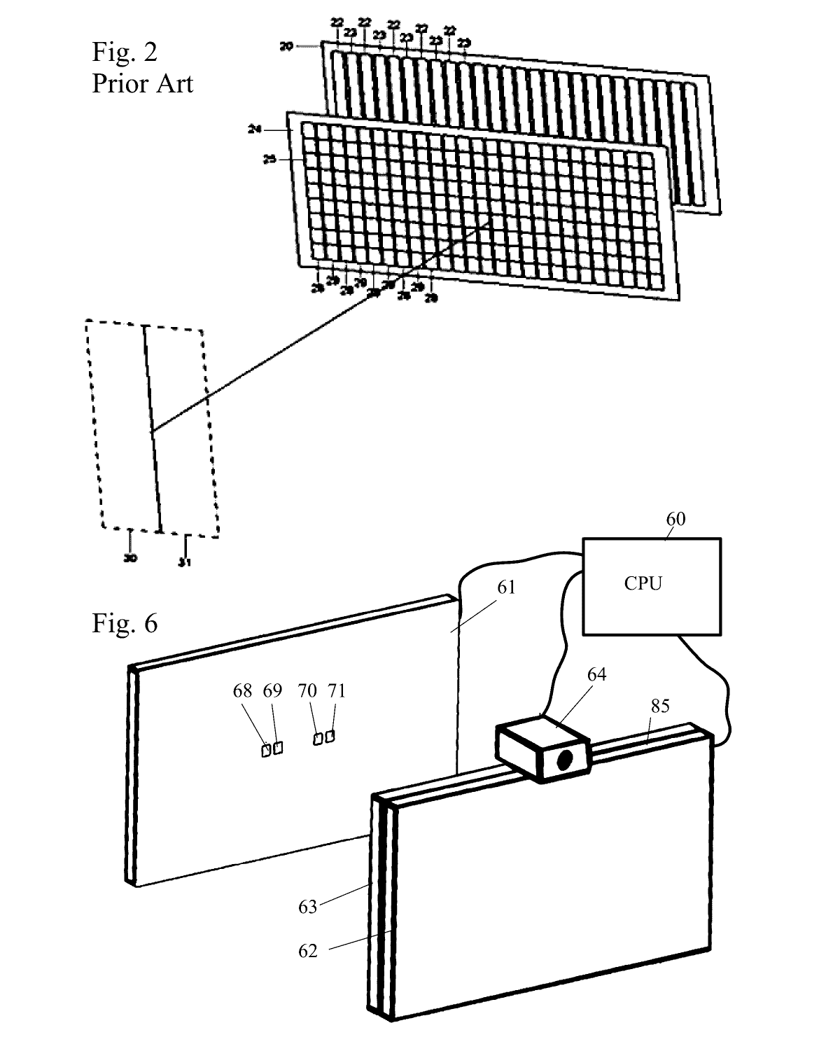

The simplest case for full resolution head tracking is that in which two sets of blinking light lines are used, as described above, and the head or eye tracking device determines when the eyes of the observer are crossing the boundaries between two viewing zones. When such crossing happens, the system changes the timing of the image display or the timing of the light lines, to cause the left eye perspective view to become visible in what was formerly the right eye viewing zone, and the right eye perspective view to become visible in what was formerly the left eye viewing zone. A superior arrangement can be had, as shown in FIG. 3, if four sets of light lines are used, one pair 41 and 43 being a blinking pair of two lines as described above, and the second set 42, 44 being spaced an equal distance between the members of the first pair, as shown in FIG. 3. It is best that in the case of a two view system, the lines are oriented parallel to the pixel columns, but slanted lines can also be used.

This lighting arrangement operates as follows:

At any given time two of the light lines in each pair will be alternately flash on and off. As an example, light lines 41 and 43, or light lines 42 and 44, will be turned on depending on the head position given by the web cam system or other head or eye tracker. Each light line can be split into four subsections. Each subsection can then be turned on in sequence to follow the scan of the LCD from top to bottom.

Which set of two lines is flashing on and off is determined by information from the head tracker, interpreted by appropriate software. The software (open source examples are available) will calculate the horizontal position of the observers' head and translates this information into a signal which tells which of four possible flashing patterns are used (this signal can be a simple binary number: 00, 01, 10, and 11).

When the observer's head is within a certain 31.5 mm wide area (typically at about 30 inches viewing distance), light 41 and 43 will flash on and off in all sets while the LCD is scanned and displays two fields alternately; containing interleaved left and right images. Light 41 will flash when the odd numbered fields are displayed and light 43 will flash when the even numbered fields are displayed. If the lines are oriented parallel to the vertical pixel columns of an LCD operated in landscape mode, the columns of LEDS can be split into several sections (ideally 4 or more) and each section of each line set will turn on after a certain delay after the pixel rows in front of it have been addressed and the pixels in front of it change to the next image, as explained in U.S. Pat. No. 5,410,345, which is incorporated herein by reference.

If the web cam or other sensor determines that the observer's head has moved into the next 31.5 mm wide area to the left, lines 41 and 43 will stop flashing and lines 42 and 44 will start flashing. If the observer's head moves into the next 31.5 mm area to the right, lines 41 and 43 will start flashing again but in reverse order, i.e. line 41 will flash when the even fields are displayed and lines 43 will flash when the odd fields are displayed. If the head moves into the next 31.5 mm wide area to the right, lines 42 and 44 will start flashing again, but in the same reverse order. If the head moves to the next 31.5 mm wide area to the right, lines 41 and 43 will flash again in the original order.

When the observer moves to the right, the changes to the line sets and flashing sequences proceed in the reverse order, to cause the viewing zones to shift right to follow the eyes. When the observer changes direction, the changes to the line sets and flashing sequences proceed accordingly to cause the viewing zones to follow the eyes.

### Six Sets of Lines

The case where six sets of lines are present is illustrated in FIG. 4. Here there are six sets of lines marked 51 through 56. Two lines with two lines between them will be flashing at any given time in synchronization with the LCD to create full resolution images, for example lines 51 and 54. Using three sets of lines allows the change from one zone position to the next to occur when the observer's eyes are farther from the edge of the viewing zones, and thus allows for more lag on the part of the system and less stringent accuracy requirements for the sensor, and faster movement on the part of the observer without double images or flicker due to changes in image brightness of artifacts becoming visible as the observer's eyes get near the edges of the viewing zones.

The straightforward way to operate the system with six sets of flashing lines is as follows:

When the observer's head is within a certain 21 mm wide area, typically at about 30 inches viewing distance light 51 and 54 will flash on and off in all sets while the LCD is scanned and displays two fields alternately; containing interleaved left and right images. Light 51 will flash when the odd numbered fields are displayed and light 54 will flash when the even numbered fields are displayed. As before, if the lines are oriented parallel to the vertical pixel columns of an LCD operated in landscape mode, the columns of LEDS can be split into several sections (ideally 4 or more) and each section of each line set will turn on after a certain delay after the pixel rows in front of it have been addressed and the pixels in front of it change to the next image, as explained in detail in U.S. Pat. No. 5,410,345.

If the web cam or other sensor determines that the observer's head has moved into the next 21 mm wide area to the right, lines 51 and 54 will stop flashing and lines 52 and 55 will start flashing. If the observer's head moves into the next 21 mm area to the right, lines 52 and 55 will stop flashing and lines 53 and 56 will start flashing. Further movement by another 21 mm will cause lines 53 and 56 to stop flashing and lines 54 and 51 to start flashing again but in reverse order, i.e. line 51 will flash when the even fields are displayed and lines 54 will flash when the odd fields are displayed. If the head moves into the next 21 mm wide area to the right, lines 52 and 55 will start flashing again, but in the same reverse order. If the head moves to the next 21 mm wide area to the right, lines 53 and 56 will flash again in the same reverse order. If the head moves to the next 21 mm wide area to the right, lines 54 and 51 will flash again but now in the same order as in the start of this example.

### N Sets of Lines

The case where N sets of lines are present can be described as follows. Its operation can be described as follows: given a viewing zone width of W, which is typically set at 63 mm for viewing by average adults, the detector and related software and electronics are designed to signal a light line set change whenever the eyes or head are found to have moved outside of certain regions that are W/N wide. If the lines are labeled 1−N, then when the observer is in some given region that is W/N wide, then line sets 1 and N/2 will flash on and off. When the observer moves W/N to the left, sets 2 and N/2+1 flash on and off, and so on, until the observer moves far enough that sets N−1 and N/2−1 are flashing. Further movement in the same direction then causes lines 1 and N/2 to start flashing again, but in reverse order from the starting condition. Flashing of the different line sets in reverse order continues as the observer moves in the same direction, until lines 1 and N/2 are flashing again. By this time the observer has returned to his or her starting position and the lines flash in the original order.

### Hysteresis

In any of the previous arrangements, if the observer stops at or near the location that causes the line sets to switch, the systems just described may cause the lines sets to switch and off and the images to flip continuously. This will likely be annoying to the viewer. To prevent this problem, hysteresis can be introduced into the control system, wherein the positions where a change between lamp sets occurs when the observer is moving to the right will be offset slightly from the positions where the changes between flashing lamp sets occur when the observer is moving to the left. Thus if the observer moves and then stops at or near any of change points, a single line switch and or image flip will occur, and the system will stay in that state until the observer has moved a considerable distance one way or the other. The operation of a system with hysteresis is described in DTI patent U.S. Pat. No. 5,349,379, which is incorporated herein by reference.

### 2D/3D Operation

In 2D mode, all the light lines will turn on steadily to provide even illumination to the LCD. Typically the light sources will be turned down in brightness so as to provide the same image brightness as in 3D mode; since the light sources are shining steadily, instead of flashing on and off, their brightness must be turned down to provide the same amount of light. Switching from 2D to 3D can be provided by a user controlled switch or via software, as with previous display devices manufactured by Dimension Technologies Inc., the assignee of the present application.

### Illumination System Design

The backlight is of considerably different configuration than ordinary backlights due to the need to focus light into hundreds of thin vertical lines. The type of backlight used is illustrated in FIG. 5, which is a top view. It consists of three major components: a bank of OTS light sources 71, a lenticular lens 72, and a diffuser 73. This generic type of DTI backlight with variations is described in U.S. Pat. No. 5,349,379, which is incorporated herein by reference, and other Dimension Technologies Inc. patents.

Several possible types of and configurations of light sources are described in a co-pending application entitled “Backlighting for Head Tracking and Time Multiplexed Displays”, filed on Jul. 1, 2016, Ser. No. 15/200,954, which is incorporated herein by reference.

The light sources can be linear light sources, such as CCFL lamps or independently controlled linear sections of an OLED illuminator, or small light sources that can be arranged in straight rows, such as LEDs. Another option is a collection of linear light guide channels, illuminated by LEDs at their ends, or containing fiber optic strands the emit light evenly along their length. The light sources ideally must have turn on and off times of 1 or 2 ms or less, allowing different banks of lights to turn on and off for head tracking and full resolution without causing flicker. Most of the light sources considered for use with off axis 3D displays consist of columns made up of many individual smaller light sources with gaps of dark material between them. This is the ideal arrangement, since light sources in general tend to be reflective, and using columns of small light sources with black space between minimizes the overall reflectance of the light source plane and thus helps to minimize cross talk (ghosting) due to reflected and scattered light.

Light from the light sources is focused into hundreds of small vertical lines by a lenticular lens. The lenticular lens is a sheet of hundreds of small cylindrical lenses molded into a piece of plastic which is usually laminated to a stiff piece of glass. Turning different sets of light sources on and off can cause the light lines to focus in different positions on the diffuser. Thus is it possible to create different sets of light lines that flash on and off for full resolution imaging by flashing different sets of light sources on and off, and to cause light lines to move to different positions for head tracking by turning different sets of light sources on and off. To produce 2D illumination, all of the columns of light sources will turn on in order to turn all of the light lines on and thereby flood the diffuser with light, creating even diffuse illumination which makes all of the pixels on the LCD visible to both eyes.

The lines of light focused by the lenticular lens are focused onto a diffuser which is mounted on glass or plastic. The diffuser scatters the light from each line and washes out hot spots and lighting artifacts that would otherwise be visible due to the presence of many small discrete light sources and the lenticular lens. The diffuser is mounted directly behind the LCD.

Due to the low light loss through the 3D optics, power consumption it will be similar to that of a normal backlight with similar brightness.

### The Lenticular Lens

A lenticular lens is designed to focus light from the fairly limited number of light sources into a hundreds of lines of light. A lenticular lens consists of an array of many small cylindrical lenses spaced across one surface of a transparent sheet. As an alternative to a lenticular lens, a fly's eye lens could also be used. A fly's eye lens consists of an array of many small spherical lenses arranged in straight rows and columns and spaced across a surface of a transparent sheet. Both lenticular and fly's eye lenses are well known to the art.

The lenticular lens is mounted with its cylindrical lenses oriented parallel to the columns of light sources. The lenses must be designed with a center to center pitch and focal lengths of the correct values to cause the images of the light sources, which form the light lines, to all be superimposed on each other on the diffuser. The distance between the lenses and the diffuser must thus be made equal to the focal distance to the light lines, which is usually expressed as the distance between the lenses and the plane where the light lines focus along lines running normal to the overall lenticular lens plane. This will result in sharp line seen on the diffuser from locations that are more or less directly in front of the center of the display.

### Diffuser

The main function of the diffuser, on which the light lines are focused, is to diffuse out any unevenness in the illumination caused by “hot spots” from individual light sources, and diffraction and moire effects from the lenticular lenses. The ideal diffuser will diffuse light across only a very small angle in the direction perpendicular to the light line directions, but will in many cases have to diffuse light across a much wider angle in the direction parallel to the light lines.

In the direction perpendicular to the light lines, the diffuser typically only has to diffuse out slight high spatial frequency artifacts caused by diffraction patterns off of the lenticular lenses interacting with pixel boundaries to create high spatial frequency moire effects. The amount of diffusion needed in that direction is typically on the order of ½ degree to 2 degrees full width half maximum for a Gaussian diffuser. If the light lines are created by continuous linear light sources behind the lenticular lens, there will not have to be any diffusion in the direction parallel to the lines. However, if the light sources behind the lenticular lens consist of columns of small light sources, such as LEDs, separated from each other, then the amount of diffusion needed parallel to the lines must be sufficient to diffuse out “hot spots” caused by the use of columns of small light sources with gaps between them. The amount of diffusion required depends heavily on the size and light sources and the size of the gaps between them, and the distance between the light sources and the lenticular lenses, but typically requires a diffusion angle of between 15 degrees to 60 degrees full width half maximum. The deal type of diffuser for use in this application is an elliptic holographic diffuser, which can be made with different diffusion angles in different directions.

It is possible to use a diffuser with a large diffusion angle in both directions, but the reflectance of diffusers generally lessens with diffusion angle, so a diffuser with a low diffusion angle in one direction will generally be less reflective than one with a high diffusion angle in both directions, and thus will create less reflected stray light and less cross talk. However, if long, continuous linear lamps, such as CCFL lamps or fiber optic strands, are used as the light source than little or no diffusion is required in the direction parallel to the long dimension of the lamps, and thus a diffuser with a small diffusion angle in both directions can be used.

### Line Turn on Follows Scan of LCD

The LCD scan to form an image will proceed from top to bottom (one long side of the LCD to the opposite long side) at a rate of (usually) about 1/60th second per scan. In such a situation the columns of light sources responsible for creating the light lines should be made from at least two, and preferably four or more independently controlled sections that can be turned on and off one after the other, proceeding from the top of the LCD to the bottom, in the same direction as the scan. The turn on time of each light source and lines will generally occur after the area of the LCD directly in front of it has been scanned, and the pixels in that section have completed their change to form the next image in the area in front of the light source. The light source and/or line turn off will generally occur just before the next scan is proceeds through the area in front of the light source and/or lines and the pixel start their change to the next image. A detailed explanation of this type of lamp operation and the timing involved relative to the LCD is contained in U.S. Pat. No. 5,410,345, which is incorporated herein by reference.

### Head/Eye Tracking System

A key requirement of the head tracking system is the lack of active emitters or passive targets worn by the user. Both open source and commercial software is available that can identify a single person's head and eyes within an acceptably wide range of positions in front of the display and calculating the head position with sufficient speed and accuracy to determine which of the size sets of viewing zones must be displayed at any given time. Examples of such head and eye tracking software are Open CV and a head-eye tracking program developed at the Fraunhofer Institute.

Specifications for one such software kit, is as follows: sampling rate: up to 60 Hz, depending on the webcam; position accuracy: X/Y 3 mm; Z (camera axis) 10 mm; tracking range 80×cm×60 cm at 80 cm distance, distance is camera dependent, typically 50 cm−1.5 cm.

Images of the area in front of the display are obtained with a simple miniature web cam which can be built into the display. It is usually best to position the head/eye tracking camera near the center of the top of the display, facing the head position of a person of average height when they are looking at the display.

### Multi Person Full Resolution Head Tracking Display

A different configuration of display is designed in such a way that multiple people can, in principle be tracked at the same time, with light from left and right eye images being directed to their left and right eyes as the move about.

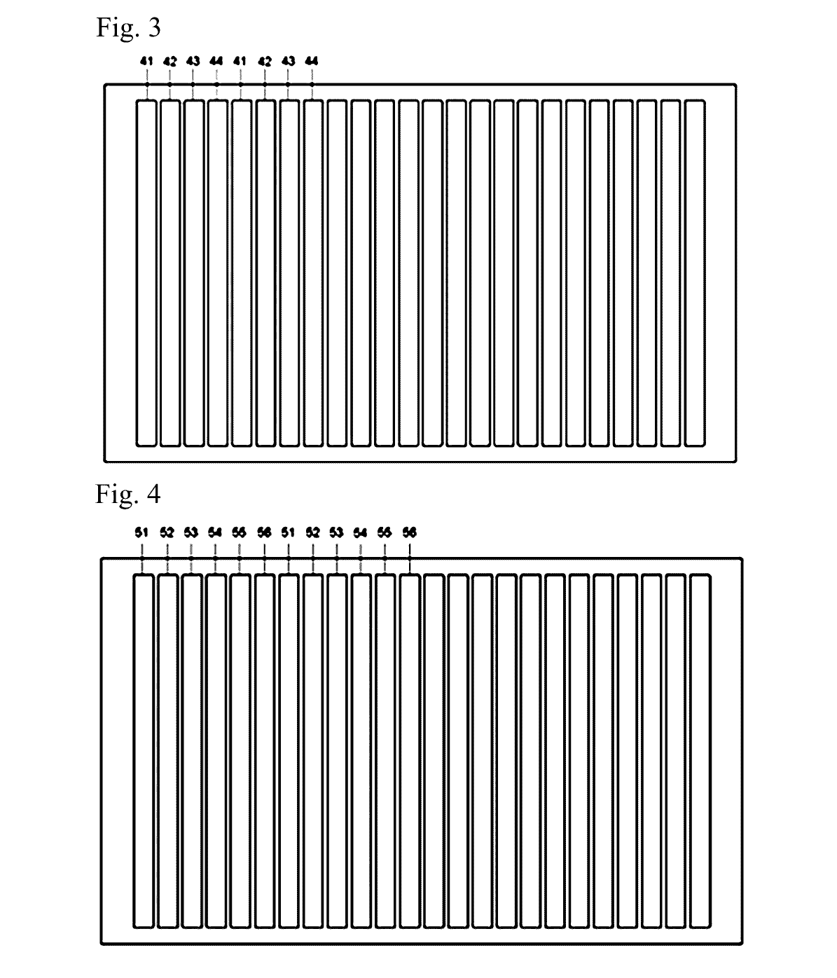

The basic concept, which was disclosed in U.S. Pat. No. 5,311,220, which is incorporated herein by reference, is illustrated in FIGS. 6, 7, 8 and 9. Generically similar concepts with certain limitations were disclosed in U.S. Pat. No. 5,132,839 (Travis), and U.S. Pat. No. 5,568,314 (Hattori), both of which are also incorporated herein by reference.

Referring to FIGS. 6-9, this configuration of autostereoscopic display 65 comprises:
(a) A light emitting panel 61, being a surface which can generate or transmit regions of emitted light. Panel 61 could be a PCB on which are mounted a number of individual LED lamps mounted in a row or rows 68-71 on a surface. Panel 61 could also be a passive, diffuse surface upon which light emitting regions from a secondary source, such as a small projector, are projected.
(b) a transmissive display 62, such as an LCD, spaced apart from said light emitting panel 61.
(c) an optical element 63, such as a Fresnel lens, located near said transmissive display 62 and being generally of the same dimensions as the display, which focuses light from the light emitting regions 68-71 on the first surface 61 onto a plane 67 spaced apart from said display 65.
(d) a computer 60 (or other device) connected to the light source panel 61, programmed to cause the regions which emit light 68-71 to blink on, then off, one after the other, and to continuously repeat the process.
(e) the computer 60 connected to the transmissive display 62 programmed to cause the image on the transmissive display to change rapidly so that a different image can be shown each time a different light emitting region is turned on,
(f) a head position sensing device 64 connected to the computer 60, located on the top portion 85 of and extending forward of display surface 62.
(g) the computer 60 is programmed to cause the light emitting regions 68-71 on the first surface 61 to move in response to data on the observer's head position provided by the head tracker or head sensing device 64, whereby the autostereoscopic image is transmitted only in the direction of the viewer of the image through the focusing action of the optical element 63.

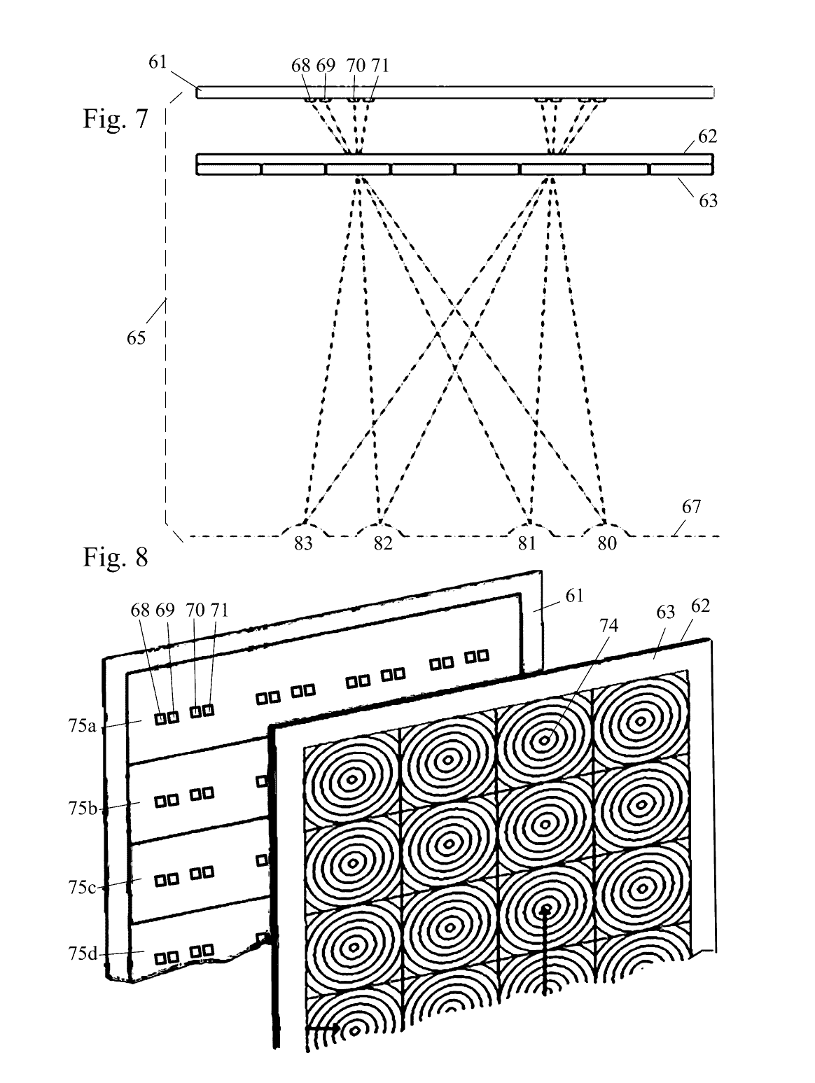

In reference to FIGS. 6 and 7, transmissive display 62—an LCD or other form of transmissive display—is placed in front of and spaced apart from the surface of the light emitting panel 61 (which for convenience will simply be referred to as panel) upon which are displayed light emitting lines, dots, or other shaped areas, shown as elements 68-71 in the diagram, although it will be understood that these are used to represent the large number of elements in the array on the panel 61, as described in detail above.

In the embodiment of FIGS. 6 and 7, the surface of the panel 61 is relatively far back from the transmissive display 62.

The lens 63 is added at or near the transmissive display 62, either between the transmissive display 62 and the panel 61, as in FIG. 6, or on the side of the transmissive display 62 away from the panel 61, as shown in FIGS. 7-9. The lens 63 serves to focus light from the surface of the panel 61 onto the viewing plane 67. The lens 63 need only act to focus light in the horizontal direction, but could also focus light in the vertical direction. The lens 63 in this position could be a convex glass or plastic lens, but a Fresnel lens is the preferred choice because such a lens will be cheaper, lighter, and more compact than a conventional convex lens.

The head and/or eye tracker 64 operates in combination with the light emitting region generation surface 61 and the computer 60 or other device which provides the images on the display. A head/eye tracking device 64 is mounted on or near the display 62. The head tracker 64 determines the location of at least one viewer's head as the viewer sits in front of the device 65. Ideally, this head/eye tracker 64 should be able to identify and track more than one observer's head.

The panel 61 is capable of displaying lines or other shaped illuminating locations, such as the squares 68-71 shown in FIGS. 6-9, anywhere across its surface and is capable of moving said illuminating locations by means of turning on different light sources on the panel 61 on or off. The illuminating locations can be moved independently on command from computer 60 based on data from the head tracking system 64. The regions are moved into such positions that the lens focuses light from locations 68 and 70 into regions in plane 67 where observers' right eyes 80 and 82 are located and light from locations 69 and 71 into regions in plane 67 where observers' left eyes 81 and 83 are located.

The computer 60 is programmed to cause the panel 61 to sequentially flash light emitting locations 68-71 on, then off, one after the other so that each in turn is focused by lens toward the viewer's eyes 80-83 located in or near plane 67. Location 68 would first flash on, and the light from it focused toward the first viewer's right eye 80. Then location 68 would turn off, and location 69 would turn on, and be focused on the viewer's left eye 81. Next, location 69 would turn off and location 70 would turn on and would be focused towards the second viewer's right eye 82, and then location 70 would turn off and location 71 would turn on to be focused toward the second viewer's left eye 83.

When location 68 is on, the transmissive display 62 would be displaying a scene with perspective appropriate to viewing from the position of the first viewer's right eye 80. When location 69 is on, a perspective view appropriate to the position of that viewer's left eye 81 would be displayed, and so on, so that each observer would see a perspective view of some scene that is appropriate to his position. The transmissive display 62 would change images between the time one emitting region 68-71 turns off and the next one turns on. Furthermore, as the observer's head moved, the computer 60 would move the locations of light emitting locations 68, 69 etc. so that they would remain focused on his or her eyes 80-83. In addition, the computer 60 could change the perspective view on the transmissive display 62 so that as the observers' heads moved, they would see a changing perspective of the object, just as they would with a real object--they could move their heads and look around corners and so forth.

The number of observers that could be accommodated with the system just described depends on the speed of the display 62 refresh rate. For example, an LCD operating at 240 fps could accommodate only two observers. However, a large number of observers could be accommodated with only a 120 fps LCD if all of the observers are shown the same two perspective views no matter where they are sitting. In such a case, the locations 69 and 71, to be focused toward all the observers left eyes 81 and 83 would be turned on at the same time, and a left eye view of a scene would be shown on the transmissive display 62. Next, all the locations, 68 and 70, that are to be focused toward the right eyes 80 and 82, are turned on at once, and a right eye view of a scene is displayed on the transmissive display. As before, the locations 68-71 would move to follow the viewers' eyes 80-83. However, the viewer would see the same perspective views as he or she moved back and forth--it would not be possible to look around corners. The effect would be identical to the effect produced with wearing polarized glasses, where all observers see the same two images.

Although two pairs of light emitting locations that provide light to be focused toward two observers are shown in FIGS. 6 and 7, more observers could be present, provided that the head tracking system is capable of sensing and tracking all of them. In such a case, a pair of light emitting locations, similar to regions 68 and 69, would be formed on the panel for each observer, and positioned on the panel in such a location that light coming from them is focused toward each observer's eyes.

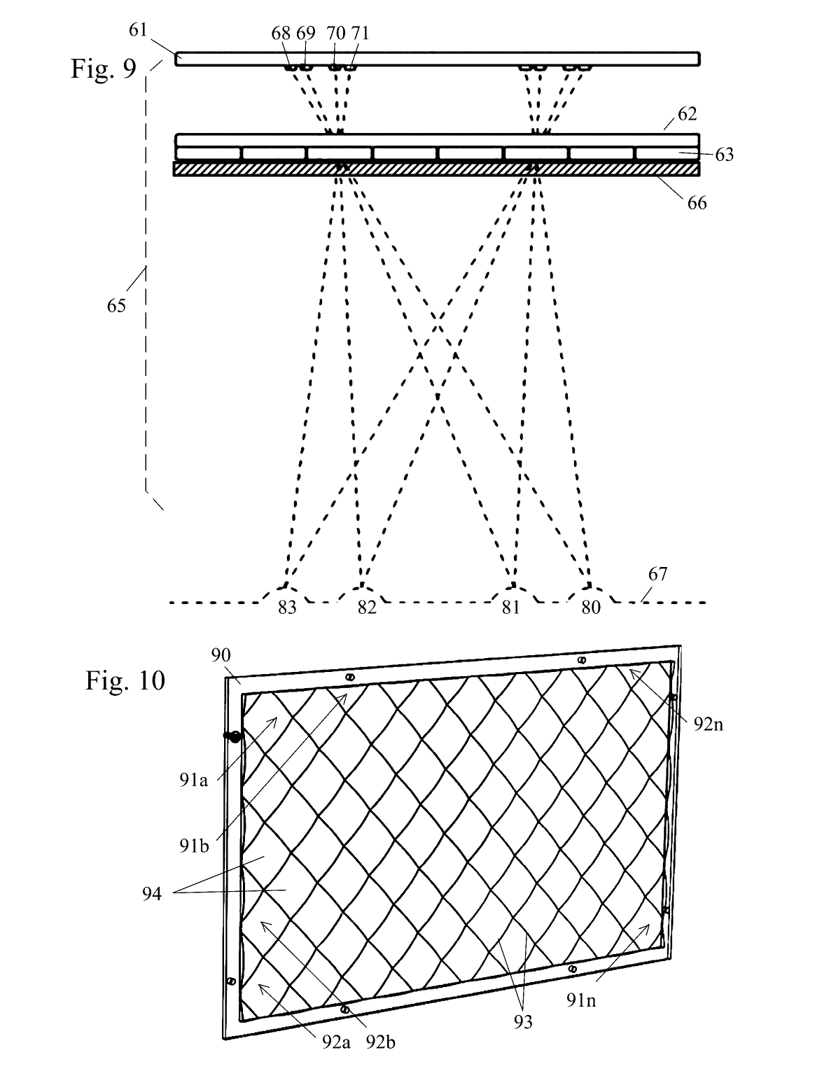

FIGS. 8 and 9 show a variation of the display shown in FIGS. 6 and 7 which is much thinner and more compact. FIG. 8 is a close up perspective view of part of the display 65. FIG. 9 is a top view of the whole display 65.

The illuminating panel 61 is situated behind and parallel to the transmissive display 62. A multiple lens sheet 63 with one square shaped convex or Fresnel lens 74 in front of separate groups of pixels on the transmissive display 62, is placed a short distance in front of the display 62. The lens 74 focuses light emitted from locations on the panel 61 onto the viewing plane 67 while the head tracker 64 keeps track of each viewer's location. Note that any number of pixels might be covered by each lens 74, from one up to a sizeable fraction of the total number of pixels on the display 62.

A set of light emitting locations 68-71 is displayed behind each group of pixels. Each light emitting location 68-71 is positioned so that it is focused toward one observer's eye in the plane. The set of light emitting regions that focus on to the observer's left eye 81 can all turn on at once, then the regions focused on that observer's right eye 80, and so on. Alternatively, all the sets of light emitting regions 69, 71 whose light is focused towards the observer's left eyes 81 and 83 might be turned on at once while a single “left eye” scene is displayed on the transparent imaging forming device and all the light emitting regions 68 and 71 whose light is focused toward the observers' right eyes 80 and 82 could be turned on next while device displays a single “right eye” scene.

Since the LCD 62 scans from the top to bottom to form new images at the rate of 120 fps, or about 8.33 seconds per scan, and the pixels take a finite amount of time to change from one image to the next after the scan (typically 2-5 ms) each lamp can be left on for the maximum amount of time, thus increasing the duty cycle and perceived brightness, if the appropriate light emitting locations (8-11) behind each section of LEDs 75a, 75b, 75c etc. are turned on in sequence immediately after the LCD is scanned and the pixels change behind the Lens array in front of that section, and don't turn off again until the pixels behind that Lens array are scanned and start to change again. Such scanning in synchronization with the scan of the LCD is described in detail in U.S. Pat. No. 5,311,220, which is incorporated herein by reference.

It was discovered that in the case of the version using an array of lenses, as shown in FIGS. 8 and 9, the lens boundaries can become visible as bright lines during seccades of the observer's eyes (rapid movement of the eyes while shifting the gaze from point to point on the image), unless an expensive lens with extremely thin boundaries is used.

### Fly's Eye Lens Design

The fly's eye lens in such a system has been envisioned and modelled as an array of plano-convex lenses arranged in straight vertical rows and horizontal columns parallel to the sides, top, and bottom of the LCD, although other possibilities such as hexagonal arrays have also been considered.

Unfortunately, the boundaries between the lenses tend to be visible due to imperfections along the boundaries and lack of perfectly sharp boundaries. This is particularly true of lenses made using inexpensive mold and/or replication processes. Furthermore, the boundaries between columns cannot be effectively blurred out with a diffuser without degrading the 3D image because the diffusion would have to occur in the horizontal direction, and would thus tend to scatter light directed toward the left eyes into the areas occupied by the right eyes and vice versa, causing “cross talk’ i.e. the visibility of the left eye view by the right eye and vice versa.

A solution to this dilemma exists in the form of a fly's eye lens 90 shown in FIG. 10, whose rows 91a 91b . . . 91n and columns 92a 92b . . . 92n—and lens boundaries 93 are tilted at a 45 degree angle, or some other large angles, relative to the edges of the display 90.

Given lenses 94 and boundaries 93 tilted in this manner, it is possible to blur them to the point of invisibility by placing a single directional or highly elliptical diffuser 66 in front of the lens 63—preferably between the lens 63 and the transmissive display 62—oriented so that its direction of maximum diffusion is parallel or nearly parallel to the left and right edges of the display, as seen by the user, and very little diffusion occurs in the direction parallel to the top and bottom edges. Such a diffuser, oriented in this manner, will not cause light to scatter between 3D viewing zones and degrade the 3D image.

Other lens shapes can also be used with this method as long as all lens boundaries are oriented such that no lens boundaries are oriented close to the vertical direction. For example, hexagonal lenses could work as long as they are oriented in such a way that no lens boundaries are oriented close to the vertical direction. Diamond shaped lenses could also be used.

### Improvements to Make the Multi Person Head Tracking Display Practical for TV and Collaborative Installations

The present disclosure presents two significant design changes that will allow the viewers of such a system to be positioned across a wide range of distances from the screen, and also will allow viewers to be positioned at +/−45 degrees off axis or more, is believed to be a minimum acceptable for audience view applications.

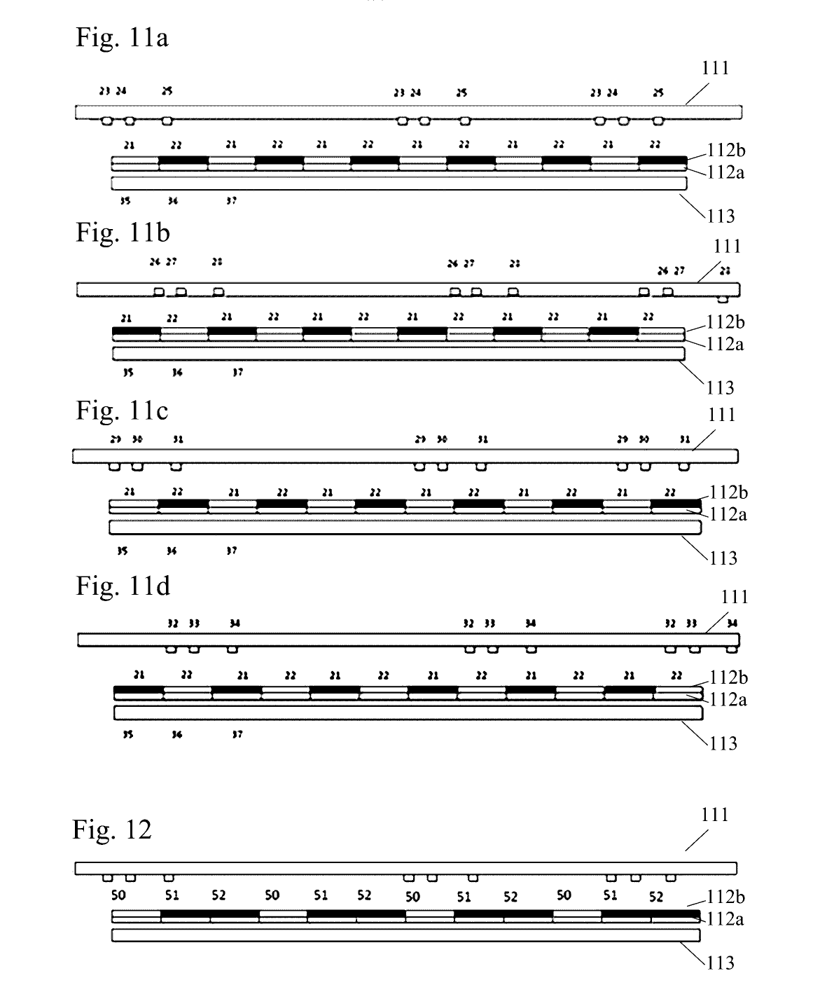

The first improvement involves a variation on the lighting scheme that will allow farther off axis viewing. This is illustrated in reference to FIGS. 11a through 11d, which shows the compact system with multiple lens arrays similar to that of FIGS. 8 and 9. In these figures, there is shown a light panel 111, the image-forming transmissive display 112a which could be a liquid-crystal display (LCD), and a lens array 113. These elements correspond to elements 61, 62 and 63, respectively, in FIGS. 8 and 9.

The first difference is that a second light-valve panel 112b, which could be a liquid-crystal display (LCD), is added behind the image forming transmissive display 112a, and behind or in front of the lens arrays 113. This second light-valve panel 112b will be a simple black and white panel, most likely a TN panel, with one section 21 or 22 behind each of the lens arrays 35-37. Each section 21 or 22 will be capable of being turned on and off independently, like a giant pixel. The sections 21 and 22 will generally be arranged in straight rows and columns, similar to the rows marked 75a, 75b, and 75c etc. in FIG. 8.

On the first scan of the image-forming transmissive display 112a used to form the first image, either L or R, every other column or section 22 of the second light-valve panel 112b are turned off, preventing light from reaching the lenses behind or in front of them, as shown in FIG. 11a. Observer eye positions are sensed across a wide angle, of up to +/−45 degrees in this particular case.

As the scan of the image-forming transmissive display 112a moves from top to bottom, appropriate lamps on panel 111 are turned on in positions 23-25 behind lens arrays 35-37, etc. in order to direct light toward the eyes of observers in different locations across the +/−45 degree area. The exact positions of the turned on lamps will be determined by information from the eye tracker. In the illustration of FIG. 11a, the image-forming transmissive display 112a is showing a left eye view, and light is being directed to the left eyes of all the observers.

Next, while the same scan is still going on, the remaining set of columns 22 on the second light-valve panel 112b will be turned on while the first set 21 is turned off. The first set of lights 23-25 will be turned off, and now a second set of lights, 26-28 will turn on that are positioned so as to send light through the second set of lens arrays, again toward the observer's left eyes, through columns 22 and lenses 33, as shown in FIG. 11b.

As the image-forming transmissive display 112a scan proceeds from the top to the bottom of the image-forming transmissive display 112a, and the pixels change to display the left image, LEDs on light panel 111 are flashed behind each lens array in turn and sections of the second light-valve panel 112b are made transparent in turn, first one set 21 then the other 22, following the same sequence as described above.

On the next image-forming transmissive display 112a scan, starting from the top, the right eye view is displayed, but now sections 22 of the second light-valve panel 112b are turned transparent, with the remaining sections 21 turning opaque, and appropriate LEDs on panel 111 are turned on to send light through lens arrays 35-37 etc. to the right eyes of the observers, as shown in FIG. 11c. The same process as described above repeats for the right eye view, as shown in FIG. 11d, with successive second light-valve panel sections in successive rows becoming opaque and transparent as the scan proceeds from the top to the bottom.

It is possible to produce a wider off axis viewing area by keeping more sets of second light-valve panel sections off at a given time, as shown in FIG. 12. For example three sets of second light-valve panel sections 50-52 can be used on second light-valve panel 112b, which gives a display that allows +/31 63 degrees off axis viewing. If sets 51, 52, etc. are kept off while sets 50 are on in then sets 50 turn opaque and sets 51 turn on, then sets 51 turn opaque and sets 53 turn on. Again, this process repeats in each successive row as the image-forming transmissive display 112a scan proceeds from the top to the bottom of the image-forming transmissive display.

A tradeoff can occur between the number of second light-valve panel sections used, the focal ratio of the lens arrays, and the off axis viewing angle.

This design does block light—about half in the simplest design, and two thirds or more in the wider angle or longer focal ratio designs—but the lighting and tracking system possesses a great advantage in that all of the light from each LED or cluster of LEDs is focused into the area surrounding the eye of the observer, instead of being allowed to diffuse evenly across the entire area in front of the display. This makes the illumination extremely bright as seen by the observer, so a considerable amount of light can be lost without producing a dim image or requiring excessively bright LEDs. Calculations show that a screen brightness of 300 nits could be achieved with the simple system described above using only 0.15 watt, 14 lumen LEDs emitting in a Lambertian pattern (120 FWHM), taking light loss at the lenses, diffuser, and LCDs into account.

A second variation is designed to allow the focusing of illumination throughout a deep volume, potentially from a distance of a few feet in front of the display to 20 or more feet away, to the far end of a room or the limit of the head tracker's range. Given small Fresnel lenses with focal lengths on the order of 50 mm (2″) it would be possible to cause the focus distance to the images of the LEDs focused in space in front of the display to move between about 2 meters from the display to 3.25 meters from the display (roughly 6½ feet to 10 feet 8 inches) by moving the lens or the LED panel back and forth by only ½ mm

This gave rise to the concept of using a back and forth vibrating lens in combination with flashing LED light sources whose flashes are timed to coincide with the point within the lenses vibration cycle that would cause the image of the LED to be focused at the distance to a sensed observer.

Referring to FIG. 14, the system in this embodiment would be constructed in the same configuration as the variations in FIGS. 11 and 12, with the exception that the lens array 143 would be mounted on a stiff frame 140 and made to vibrate back and forth between an inner limit 144b and an outer limit 144a at 120 cycles per second by an actuator 141 which may be, for example, a piezoelectric actuator or voice-coil actuator or stepping motor, or the spring loaded cam design shown in FIG. 15 and described below, or some other actuator known to the art. The vibrating lens arrangement can also be used in the manner described below in the simpler system shown in FIG. 6, where no second LCD 112b is present.

This arrangement would allow one complete cycle to occur behind each of the rows of lenses during the time that LEDs behind the lenses are turned on. Due to the scan rate and pixel response of the LCD, each new image should be visible on any given section of the LCD for about ½ of each 1/120th second frame before the next image starts to form; therefore lights behind that section, intended to direct light from that image to an observers eye, can turn on and off any time within a 1/240th second period.

Information from the head tracker on the distance to the user will be used to calculate (or most likely look up on a table) the time period that a given LED turns on within the vibration cycle from outer 144a to inner 144b and back. Due to the small size of the lenses and the observing distances involved, a given light source behind a given row of lens arrays could remain on for as much as ⅓ of each “out” 144b to 144a or “back” 144a to 144b stroke. This does not reduce the duty cycle much beyond the roughly ½ needed for the operation of the system as described in FIG. 12, and brightness loss due to low duty cycles will not be an issue.

Another option, shown in FIG. 15, could be the use of a vibration mechanism involving a series of synchronized motors 150 utilizing offset cams 151, which would press against a spring loaded frame 152 around the lens arrays 153. The lens array 153 should be made of sufficiently thick plastic with the right stiffness and natural vibration frequency to avoid flexing during the vibration cycle. However, some flexing can be tolerated and even compensated for through lamp timing as long as it is a known quantity and stays consistent from cycle to cycle.

### Curved Light Line Panel Substrates

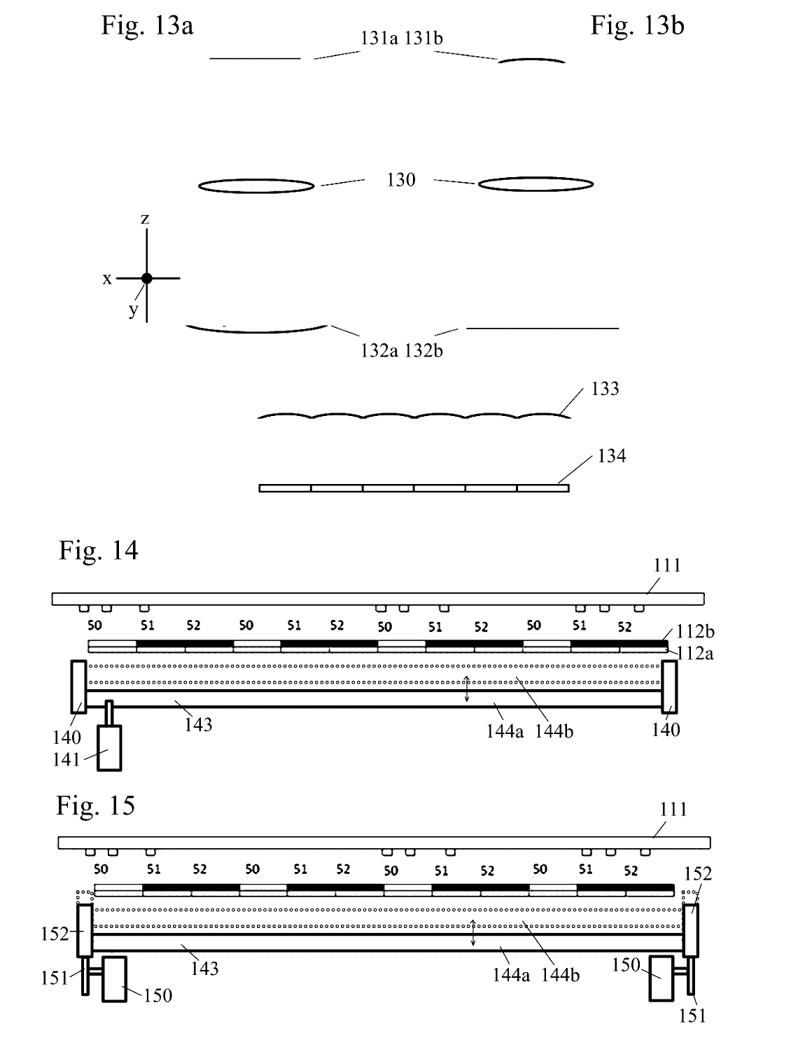

Another improvement for far off axis viewing from across a wide angle is the use of a light emitting panel 133 that is curved in a scallop pattern behind the fly's eye or lenticular lens array 134, as shown in FIGS. 13a and 13b, which show a top view of the object plane 131a/131b and image plane 132a/132b of a lens 130. For the purpose of these figures, the “z” axis runs vertically on the page, with the “x” axis from side to side and the “y” axis into and out of the paper.

Convex lenses 130, including arrays of convex lenses and Fresnel lenses like those described above focus differently far off axis that they do on axis. In the designs described above, a series of light sources is placed in a plane behind one or more lenses, and the lenses are intended to focus the light from the light sources into a single plane in front of the display where observers are located.

However, if light is emitted from a given flat object plane 131a behind a lens 130, the lens 130 will tend to focus the light into a curved image plane 132a in front of itself, with the off axis portions of the image plane 132a curved in closer to the lens 130 along the z axis. For fly's eye lenses, the curvature is in both the x and y directions, but for observers do not generally get very far off axis in the up and down direction, so we are only concerned for now with the side to side direction, as illustrated in FIG. 13a.

It some situations both on axis and off axis observers will always be close to the same flat plane which will be parallel to the surface of the display and spaced some distance from it. Examples of such situations include a display intended for use by both the pilot and copilot in an aircraft, and a display meant to be seen by both the driver and passenger in an automobile. When using simple, single element lenses the only way to obtain a flat image plane 132b in order to direct light to all observers in that object plane is to start with a curved object plane 131b. A curved object plane 131b designed to create a flat image plane 132b is illustrated in FIG. 13b.

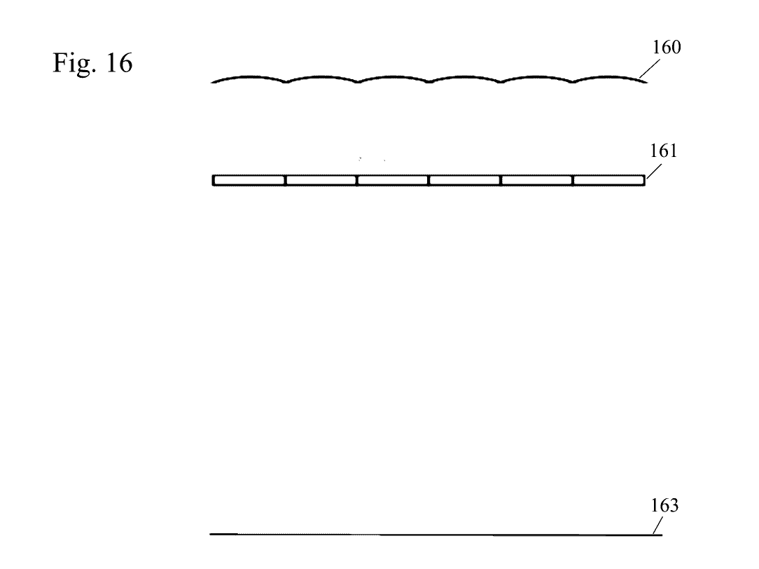

FIG. 16 illustrates a head tracking display using an array of fly's eye lenses 161 behind an LCD display 160, similar to the one shown in FIG. 8, but with the light emitting panel 160 curved forward from the middle to the sides behind each of the fly's eye lenses 161, creating a scalloped pattern as shown. It would generally be necessary to curve the light emitting panel 160 only in the horizontal direction, creating a series of semi-cylindrical curved sections with their axes in the vertical direction, out of the page of the drawing. Such a curved plane could easily be created if fiber optic emitters were used as the light sources. Side emitting fiber optic strands could be mounted in channels on the surface of the curved sections, as is shown in a co-pending application entitled “Backlighting for Head Tracking and Time Multiplexed Displays”, filed on Jul. 1, 2016, Ser. No. 15/200,954, which is incorporated herein by reference. The backlight has the strands parallel to the cylindrical axis. Point like light sources could be made by letting the ends of fibers stick out of holes in the curved sections even if they were curved in both the horizontal and vertical directions, creating a two dimensional array of scallop depressions.

As an alternative to the use of a scalloped light emitting panel, it is possible with some designs to place a second fly's eye lens or lenticular lens (not shown) close to a flat light emitting panel so that when seen through the lens, the surface appears to be curved behind each of the lenses. The first fly's eye lens shown in FIG. 16 will re image this curved image into a flat plane.

### 2D/3D Operation

In all of the embodiments described above in relation to FIGS. 6-16, the display could be switched to 2D mode for the display of full resolution 2D images by turning on all the light sources at once and keeping them steadily, usually at lower brightness that in flashing mode, so that the brightness of the display will remain equal in the 100% duty cycle 2D and the low duty cycle 3D modes.

### Eye Tracking Options

There are several options available for tracking the heads and/or eyes of multiple observers situated in front of a display. The best and most advanced options can utilize nothing more than a miniature video camera plus software that is capable of identifying eyes either passively or by means of infrared reflection, and continuously reporting their position to other parts of the system. Most are designed primarily with one tracked person in mind, but can in principle be extended to two or more people given a fast enough computer to make the extra calculations. All can in principle also report on the eye's positions in the Z direction as well as X and Y, by establishing the eye image separation on the camera at a certain distance and using variations in this separation to calculate changing observer distances. Both commercial versions and open source versions exist; all at this time employ software running on PCs, but in principle such software could be coded on an FPGA chip or ASIC for use in a commercial product.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of operating an autostereoscopic display system for displaying a stereoscopic image comprising alternating left-eye and right-eye images, creating a 3D effect for an observer in front of the display, the observer having a head with a right eye and a left eye located in a viewing zone having a width W, the display comprising a backlight having an array of multiple independently controlled columns of light sources divided into N sets of light sources, each set of light sources having a set number; a lens array in front of the backlight; a transmissive display in front of the lenticular lens for displaying the stereoscopic image, through which lines of light from the light sources are directed by the lens array; a head tracking device adjacent to the transmissive display for detecting a position of the observer in front of the display; and a computer coupled to the backlight, the transmissive display and the head tracking device; wherein a light line set change is defined as whenever the observer has moved outside of a region having a width of W/N, the method comprising:
a) the computer using data from the head tracking device to determine in which of the plurality of viewing zones the observer's head is located;
b) the computer determining the set number of a first set of columns of light sources which will cause an image from the transmissive display to be directed to the viewing zone in which one of the user's eyes is located, and determining the set number of a second set of columns of light sources as the set number of the first set of columns of light sources plus N/2;
c) the computer flashing the first set of columns of light sources and the second set of columns of light sources alternately while displaying the stereoscopic image on the transmissive display, such that the first set of columns of light sources is flashed on while one of the left-eye or right-eye images is displayed on the transmissive display and a the second set of columns of light sources is flashed on while an opposite one of the right-eye or left-eye images is displayed on the transmissive display, so that the observer sees a three-dimensional stereoscopic image;
d) the computer using data from the head tracking device to determine in which of the plurality of viewing zones a horizontal position of the observer's right eye and left eye are located;
e) if the computer determines that a light line set change in a direction of movement has occurred, then:
i) the computer incrementing or decrementing the set numbers of the first set of light sources and the second set of light sources, depending on the direction of movement of the observer's head;
ii) if the set number of the first set of light source equals N, then the computer reversing the left-eye and right-eye images assigned to the first set of columns and the second set of columns; and
f) the method repeating from step (c).

2. The method of claim 1, in which the width W of the viewing zone is 63 mm

3. The method of claim 1, in which the number of sets N is 4.

4. The method of claim 1, in which the number of sets N is 6.

5. The method of claim 1, in which in step (e), hysteresis is introduced by determining that a line set change has occurred when the observer is moving to the right at a position which is offset from a position where a line set change occurs when the observer is moving to the left.

6. The method of claim 1, further comprising a step of the computer entering a two-dimensional mode of operation in which all of the columns of light sources are turned on.

7. The method of claim 6, in which a level of illumination of the columns of light sources is reduced in two-dimensional mode so as to provide a same image brightness as in 3D mode.

8. The method of claim 1, in which the display further comprises a diffuser between the lens array and the transmissive display.

9. The method of claim 8, in which the diffuser is between 15 degrees and 60 degrees full width half maximum in a direction parallel to the columns of light sources and between ½ and 2 degrees in a direction perpendicular to the columns of light sources.

10. An autostereoscopic display comprising:
a) a backlight comprising a plurality of independently controlled light sources;
b) an image-forming transmissive display in front of the backlight;
c) a lens array for focusing the image from the transmissive display, located in front of the image-forming transmissive display and comprising a plurality of lenses; and
d) a second light valve panel adjacent to the image-forming transmissive display, the second light valve having a plurality of sections, each of the plurality of sections being located in alignment with at least one of the lenses of the lens array and being controllable from transmissive to opaque.

11. The display of claim 10, in which the second light valve panel is between the backlight and the image-forming transmissive display.

12. The display of claim 10, in which the image-forming transmissive display is a liquid-crystal display.

13. A method of displaying a three-dimensional stereo image comprising alternating right-eye and left-eye images for viewing by an observer, using an autostereoscopic display comprising a backlight comprising a plurality of independently controlled light sources; an image-forming transmissive display in front of the backlight; a lens array for focusing the image from the transmissive display, located in front of the image-forming transmissive display and comprising a plurality of lenses; and a second light valve panel adjacent to the image-forming transmissive display, the second light valve having a plurality of sections arranged in columns, each of the plurality of sections being located in alignment with at least one of the lenses of the lens array and being controllable from transmissive to opaque, the method comprising the steps of:
setting alternating columns of sections of the second light-valve panel to transparent and opaque, preventing light from reaching the lenses of the lens array aligned with the opaque sections;
performing a first scan of the image-forming transmissive display, displaying a right-eye or left-eye image;
reversing the sections of the second light-valve panel, such that opaque sections are set to transparent and transparent sections are set to opaque;
performing a second scan of the image-forming transmissive display, displaying the other left-eye or right-eye image of the three dimensional image; and
repeating the method for subsequent scans of the image-forming transmissive display.
